(19) United States
(12) Patent Application Publication
(10) Pub. No.: US 2012/0111662 A1
(43) Pub. Date: May 10, 2012

(54) ENGINE EXHAUST

(75) Inventor: Hugo CASADO ABARQUERO, Madrid (ES)

(73) Assignee: AIRBUS OPERATIONS, S.L., Getafe (ES)

(21) Appl. No.: 13/291,130

(22) Filed: Nov. 8, 2011

Related U.S. Application Data
(63) Continuation of application No. PCT/ES10/70171, filed on Mar. 24, 2010.

(30) Foreign Application Priority Data
May 8, 2009 (ES) 200930143

(51) Int. Cl. F02K 1/08

(52) U.S. Cl. 181/216

(57) ABSTRACT

It presents the novelty that the duct (6) for the exhaust (4) comprises at least two telescopic sections (5) with their corresponding perimetric acoustic cavities (7), in order to permit the length of the duct (6) to be varied and achieve a required attenuation of the noise produced in the combustion.

By extending the sections (5) the attenuation of the noise is increased and by retracting them it is decreased, obtaining an exhaust (4) that is adapted to the needs of the noise required in each moment.

It is applied to the exhaust of the APU of an aircraft, designed with the smaller dimensions of the exhaust (4) improving the aerodynamic conditions of the aircraft. So when the aircraft is in flight, in which the requirement of noise attenuation is less, the exhaust (4) is maintained in its retracted position, while when the aircraft is on the ground it is extended for greater attenuation of the noise, as is required on ground.

### OBJECT OF THE INVENTION

As stated in the title of this descriptive specification, the present invention relates to the exhaust of an engine comprising a duct with silencer consisting of perimetric acoustic cavities in such a way that permits the combustion gases of the engine to be expelled and, at the same time, attenuate the noise produced by that combustion. The invention has the aim of providing a variable length duct, depending on the noise attenuation that needs to be obtained at different moments, for which purpose the duct consists of telescopic sections allowing that length to be modified.

In general, the invention is applicable to the exhaust of any combustion engine in which it is required to modify the attenuation of the exhaust noises, and particularly the invention is applicable in the aeronautical industry, more particularly it is applied to the exhaust of the auxiliary power unit (APU) fitted in an aircraft.

### BACKGROUND OF THE INVENTION

The use of an auxiliary power unit (APU) in an aircraft nowadays is well known. This unit provides an electrical and/or pneumatic power supply for the aircraft and in most cases it is fitted in the tail-cone on account of the noise produced by the combustion engine of the APU, the high risk of fire that it has, the high exhaust temperatures and the need to carry out maintenance on it.

Therefore, current installations of the APU constitute dimensioning criteria for the surface of the rear part of the plane. This implies a problem for aerodynamic optimization and induces a greater aerodynamic resistance and weight for the tail-cone of the aircraft.

When the exhaust of the APU is designed, the following parameters have to be borne in mind:
diameter of the exhaust, which depends on the exhaust flow of the APU and has the drawback that a too small diameter increases the backpressure in the APU at the same time it increases the temperature in its interior, increases the flow speed and increases the exhaust noise.

On the other hand, a too large diameter increases the aerodynamic resistance of the aircraft since the tail-cone has to be designed with larger dimensions.
The length of the exhaust, which depends on the required attenuation of the noise of the exhaust. A too short length reduces the surface treated for attenuating the noise.

On this point it can be stated that the desired noise attenuation is a parameter that is not considered when the aircraft is flying, whereas when it is on the ground the noise reduction requisites are indeed applied, therefore, the dimensioning of the length of the exhaust is done as a function of the requirements established for the case in which the aircraft is on the ground, to which determines a greater length of exhaust and as a consequence a larger tail-cone which induces a greater aerodynamic resistance and weight for the tail-cone.

In the state of the art there does not exist any exhaust that permits its length to be adjusted as a function of the required noise attenuation

### DESCRIPTION OF THE INVENTION

In order to solve the drawbacks and achieve the objectives stated above, the invention has developed a new exhaust for an engine which, as with those provided in the state of the art, comprises a duct with a silencer consisting of perimetric acoustic cavities for expelling the combustion gases of the engine and simultaneously attenuating the noise produced by said combustion; with the particular feature that the invention presents the novelty that the duct comprises at least two telescopic sections with their corresponding perimetric acoustic cavities, in such a way that permits the length of the duct to be varied as a function of the required noise attenuation.

As has already been mentioned, the invention can be applied to any combustion engine, though more particularly it is applied to the exhaust of the auxiliary power unit (APU) fitted in an aircraft.

The configuration described for the case of the APU permits the tail-cone to be designed for a minimum exhaust length adequate for aerodynamic needs in flight, in such a way that with the exhaust having a shorter length the tail-cone has smaller dimensions, which reduces its weight and provides it with a lower aerodynamic resistance.

Moreover, once the aircraft is on the ground the length of the duct can be extended in order to achieve a greater noise attenuation, as required when the aircraft is on the ground. In this case, although the duct projects from the rear part of the tail-cone, this does not affect its aerodynamics since the plane is not in flight.

In order to achieve this functionality, the inner part of the front and rear end zones of the perimetric acoustic cavities of each telescopic section comprises complementary gasket joints by means of which the sealing is maintained between the different telescopic sections in their extended and retracted configurations.

In one embodiment of the invention, means of actuation are included for the telescopic sections by which the extension/retraction of the duct is permitted to be carried out automatically.

The means of actuation for the telescopic sections for carrying out their extension/retraction can be hydraulic, pneumatic or electrical means, or a combination of them. So, for example, an hydraulic or pneumatic arm can be is provided governed by an electrical circuit allowing the extension/retraction of the telescopic sections to be carried out.

The perimetric acoustic cavities of each telescopic section have a constant cross-section throughout that section, but they also have the particular feature that these cross-sections decrease from the section closest to the engine as far as the one furthest away, so that when carrying out the extension/retraction of the duct, the perimetric acoustic cavity of each section is housed inside the perimetric acoustic cavity of the section preceding it.

This feature is provided inversely in the duct of each telescopic section which is delimited by the perimetric acoustic cavities, in other words they have a constant cross-section throughout the section but with the difference that in this case their cross-sections grow from the section closest to the engine as far as the one furthest away, in such a way that this increase in the internal diameter of the duct reduces the noise produced in the outlet, owing to the slight diffusion obtained as the diameter is increased.

One embodiment of the invention comprises means of guiding the telescopic sections for the extension/retraction of the duct. The means of guiding the telescopic sections are defined by guides provided in the interior of the duct of the telescopic sections, in which a rear telescopic section has to be housed when the duct is retracted. More specifically, the invention comprises four guides arranged longitudinally in the interior of each of the telescopic sections which has to house inside it a rear telescopic section when the duct is retracted. The four guides are arranged at 90° according to the transverse cross-section of the duct.

Said guides consist of an alignment of wheels on which the surface of the rear telescopic section rests and slides.

Below, in order to facilitate a better understanding of this descriptive specification and forming an integral part thereof, a series of figures is attached in which the object of the invention has been represented by way of illustration and non-limiting.

### BRIEF DESCRIPTION OF THE FIGURES

FIG. 1.—Shows a schematic representation of an exhaust of an APU of the state of the art.

FIG. 2.—Shows a schematic view of an embodiment of the invention in is which four telescopic sections are used and are in the extended position.

FIG. 3.—Shows a schematic view equivalent to the previous figure with the telescopic sections retracted.

FIG. 4.—Shows a preferred embodiment of the invention consisting of two telescopic sections. It also shows details of the zones in which the gasket joints have been included in the acoustic cavities so that it can be understood how the sealing of the union between the telescopic sections is achieved.

FIG. 5.—Shows a view equivalent to the previous figure in the retracted position of the telescopic sections.

FIG. 6.—Shows an example of embodiment of the guides permitting the extension/retraction of the telescopic sections to be carried out.

FIGS. 7 and 8 show separate schematic views equivalent to FIGS. 4 and 5, for the case in which the extension/retraction of the ducts is effected by means of some actuators, which allow these actions to be performed automatically.

### DESCRIPTION OF THE PREFERRED FORM OF EMBODIMENT

Given below is a description of the invention based on the figures commented on above.

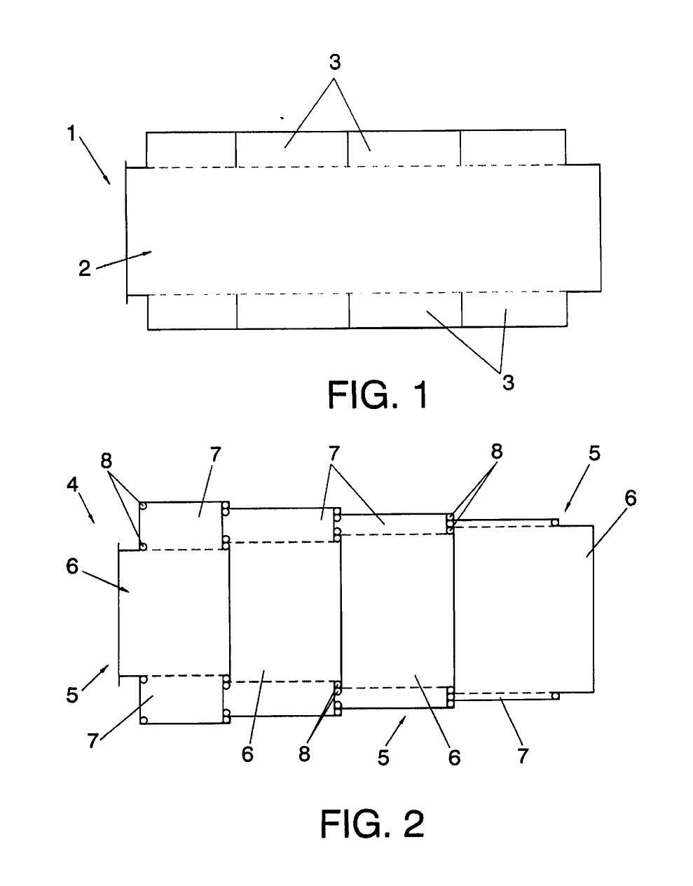

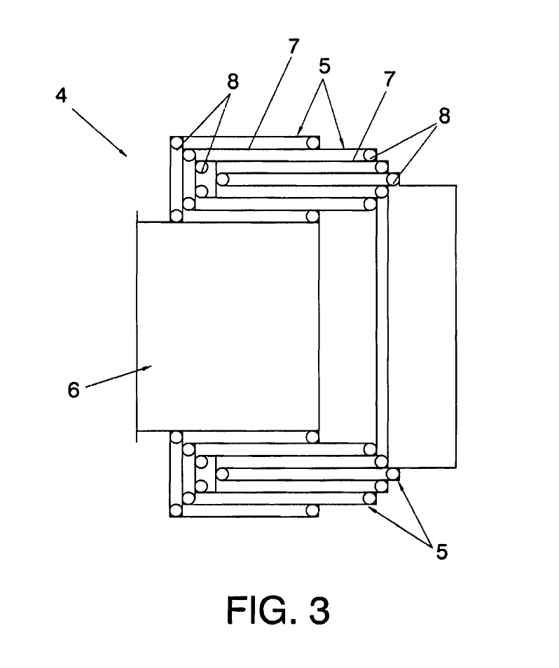

First of all, and with the aid of FIG. 1, a brief description is given of what the exhaust 1 of a conventional APU consists of. This comprises a duct 2 with a silencer consisting of perimetric acoustic cavities 3. The separation between the perimetric acoustic cavities 3 and the duct 2 is effected by means of feltmetal, which is a porous material frequently used in exhaust pipes.

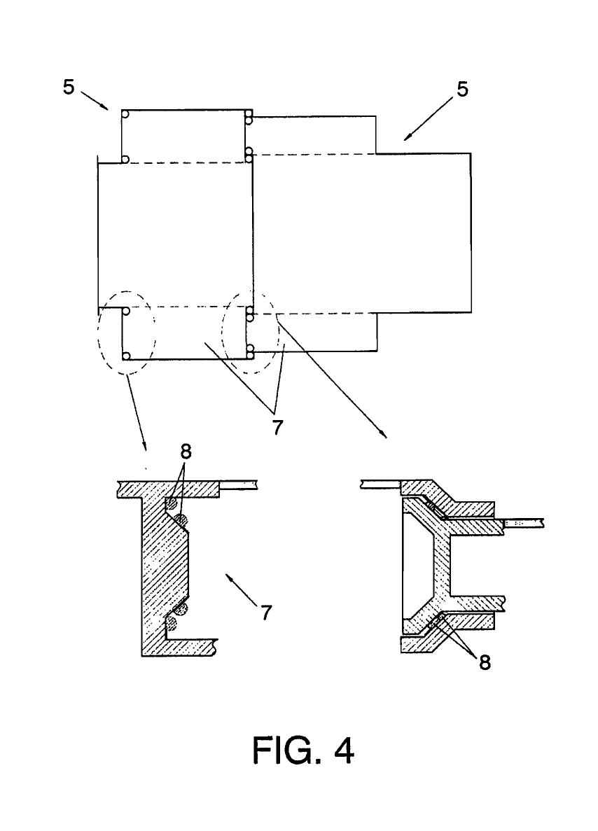

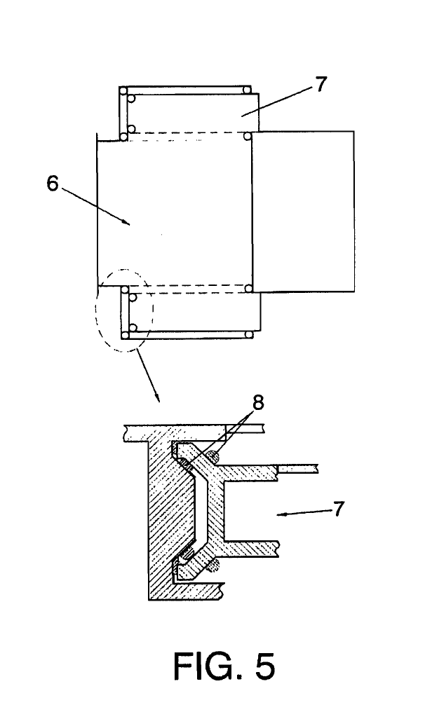

This configuration presents the problems that were described in the section on background of the invention, which are solved by means of the invention which provides an exhaust 4 of variable length, for which it comprises a series of telescopic sections 5, each of which incorporates a duct 6 and its corresponding perimetric acoustic cavity 7, each of which incorporates in its front and rear end some gasket joints 8 consisting of some seals that prevent the passage of hot exhaust gases and pressure variations from one perimetric acoustic cavity 7 to another, as can be appreciated in the details represented in FIGS. 4 and 5. In one embodiment the gasket joints 8 consist of seals known as “P-SEAIS”, though they could of course be any other of those used in the state of the art.

As can be appreciated in the figures, the perimetric acoustic cavities 7 of each of the telescopic sections 5 present a constant cross-section though this cross-section is different for each of the perimetric acoustic cavities 7, in such a way that said cross-sections decrease from the telescopic section 5 closest to the engine as far as the one furthest away. These cross-sections have a suitable dimension such that when each of the telescopic sections 5 is retracted, the perimetric acoustic cavity 7 of each of those telescopic sections 5 can be housed in the interior of the perimetric acoustic cavity of the section 5 preceding it.

On the other hand, the cross-section of the ducts 6 of each of the telescopic sections 5 grows from the section closest to the engine as far as the one furthest away, in such a way that outlet noise is reduced, as has been mentioned earlier.

In order to facilitate the extension/retraction of each of the telescopic sections 5, provision has been made for them to include some guides 9 in their interior consisting of an alignment of wheels on which the surface of the perimetric acoustic cavity 7 of the rear telescopic sections rests and slides.

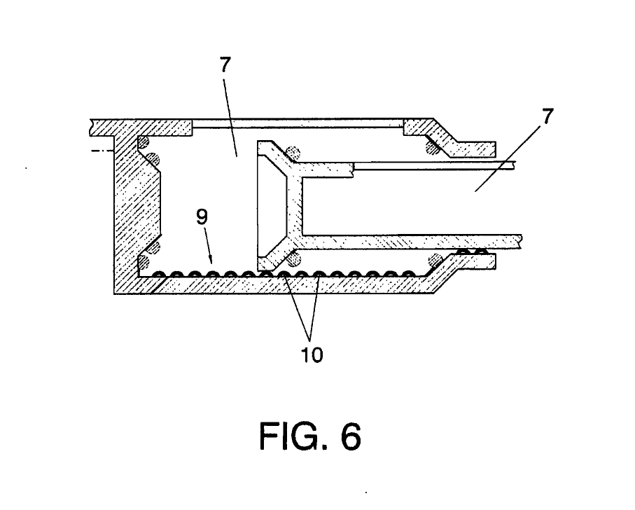

In FIG. 6, just one guide has been shown in order to simplify the figure, though in the preferred embodiment four guides are used separated by 90° according to the transverse cross-section of the perimetric acoustic cavities 7.

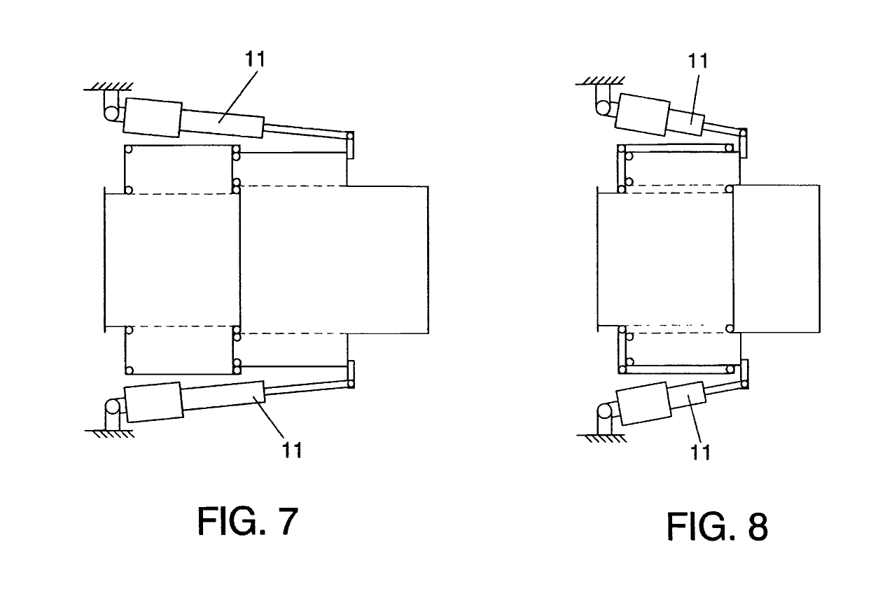

FIGS. 7 and 8 show the use of a hydraulic or pneumatic arm 11 for effecting the extension/retraction of each of the telescopic sections 5, which permits these operations to be carried out automatically.

1. Engine exhaust, comprising a duct with a silencer consisting of perimetric acoustic cavities for expelling the combustion gases of the engine and attenuating the exhaust noise generated by the engine, wherein the duct (6) comprises at least two telescopic sections (5) with their corresponding perimetric acoustic cavities (7), in order to vary the length of the duct (6) as a function of the required noise attenuation, the perimetric acoustic cavity (7) of each telescopic section (5) has a constant cross-section along the entire section, whose cross-sections decrease from the section closest to the engine as far as the one furthest away, so that when carrying out the retraction of the duct (6) the perimetric acoustic cavity (7) of each section (5) is housed in the interior of the perimetric acoustic cavity (7) of the section (5) that precedes it.

2. Engine exhaust, according to claim 1, wherein the inner part of the front and rear end zones of the perimetric acoustic cavities (7) of each telescopic section (5) comprise complementary gasket joints (8), for maintaining the tightness between the different telescopic sections (5) when the extension/retraction of them takes place.

3. Engine exhaust, according to claim 1, wherein it comprises means of actuation (11) of the telescopic sections (5) for carrying out the extension/retraction.

4. Engine exhaust, according to claim 3, wherein the means of actuation (11) of the telescopic sections (5) for carrying out the extension/retraction are selected from among hydraulic, pneumatic and electrical means and combination of them.

5. Engine exhaust, according to claim 1, wherein the interior cross-section of the duct (6) delimited by the perimetric acoustic cavities (7) of each telescopic section (5) presents a constant cross-section along the entire telescopic section (5), whose cross-sections increase from the section closest to the engine as far as the one furthest away, in order to reduce the outlet noise.

6. Engine exhaust, according to claim 1, wherein it comprises guiding means (9) for the telescopic sections (5) for the extension/retraction of the duct (6).

7. Engine exhaust, according to claim 6, wherein the guiding means (9) for the telescopic sections (5) comprise guides (9) arranged in the interior of the telescopic sections (5) in which a rear telescopic section (5) has to be housed when performing the retraction.

8. Engine exhaust, according to claim 7, wherein the guiding means for the telescopic sections (5) comprise four guides (9) arranged longitudinally in the interior of the duct (6) of the telescopic sections (5) in which a rear telescopic section (5) has to be housed when performing the retraction; said guides (9) being arranged at 90° according to a transverse cross-section of the perimetric acoustic cavities (7).

9. Engine exhaust, according to claim 8, wherein the guides (9) consist of an alignment of wheels (10) on which the surface of the perimetric acoustic cavity (7) of the rear telescopic section (5) rests and slides.

10. Engine exhaust, according to the above claims, wherein it is applied to the exhaust (4) of the auxiliary power unit fitted in an aircraft.
